(19) United States
(12) Patent Application Publication
(10) Pub. No.: US 2026/0233586 A1
(43) Pub. Date: Aug. 13, 2026

(54) Adaptive Windshield

(71) Applicant: Abhishek Ray, Toronto (CA)

(72) Inventor: Abhishek Ray, Toronto (CA)

(21) Appl. No.: 19/048,853

(22) Filed: Feb. 8, 2025

(51) Int. Cl. B60J 1/04; B60J 1/00; B62D 35/00

(52) U.S. Cl. CPC B60J 1/04; B60J 1/004; B62D 35/005

(57) ABSTRACT

A device including a windshield affixed to a frame or a frameless windshield, a mounting frame and mechanism to adaptively change the position of windshield. The mounting frame is affixed to the vehicle body, while the windshield frame or frameless windshield can change its position with respect to the mounting frame. This allows the angle of the windshield with respect to the mounting frame to change. The change in relative position is achieved by using a combination of pneumatic arms, hydraulic arms, hinges and/or pivots depending on the setup that has been opted. The gap between the two frames can be covered by a collapsible hard or soft awning depending on the configuration chosen.

### FIELD OF THE INVENTION

The present invention relates generally to a vehicle windscreen system for a vehicle and, more particularly, to a vehicle that changes the windscreen position to adapt to external conditions.

### BACKGROUND/SUMMARY

### BACKGROUND OF THE INVENTION

The windshield has been a constant feature over the decades of vehicle evolution. Conventionally this has been custom designed for each vehicle, mostly at a fixed angle based on the purpose and target audience.

Slower offroad vehicles typically have windscreens which are closer to a right angle to direction of travel, as this helps the dirt slide off easily. Since these vehicles are prone to uneven surfaces, this design also channels the force of jerks from the top to bottom of the windshield, as opposed to being directed into the vehicle's cabin for a heavily inclined one. When the vehicle is in motion, the airflow is towards the sides of the windscreen as well as above, as there is little incline to direct the majority of the flow upwards.

Faster vehicles are designed to be streamlined on the other hand, have heavily inclined windshields, obtuse angle measured from the direction of travel, as they are designed to be more aerodynamic and go faster. When the vehicle is in motion, the airflow is towards the roof of the vehicle, as there is an incline to direct the majority of the flow upwards. At slower speeds, they would end up with dirt and snow on the windshield, and rain will flow down slower due to upward air drag and downward acceleration due to gravity components.

The static angle of a conventional vehicle's windshield is a result of complex considerations and calculations based on aerodynamics, visibility, and safety. A slant windshield can reduce drag and improve fuel efficiency, but it can also limit visibility, especially during unfriendly weather. Conversely, a near vertical windshield offers better visibility but can increase drag and fuel consumption. Vehicle manufacturers have been carefully balancing these factors to optimise the overall performance and comfort of their vehicles.

### BRIEF SUMMARY OF THE INVENTION

This invention has been developed for the purpose of obliviating the above deficiencies of a particular fixed Windshield position. The Adaptive Vision Windshield is an invention that has the potential to revolutionise the driving experience by improving road safety and increasing visibility in a changing environment.

This invention allows the vehicle's windshield to change the inclination to benefit from the changing requirements and respond to driving conditions. During rainy weather or offroading the windshield can become nearly vertical to reap benefits of such positioning, while on highways it can become inclined to reap benefits of aerodynamics.

### DESCRIPTION OF DRAWINGS

FIG. 1 is a pictorial view of the vehicle windshield and mounting frame of the invention. There are two separate frames in this configuration, the dynamic frame is affixed to the windshield, while the mounting frame is affixed to the vehicle body. There are pneumatic arms that connect the dynamic frame with the mounting frame. The arms can control the relative position of the two frames by extending or retracting. This in turn can change the angle the windscreen makes with the direction of travel.

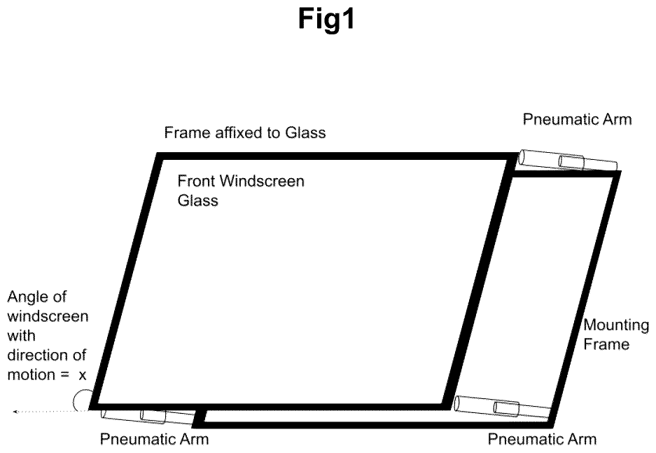

FIG. 2 is a pictorial view of the windshield with bottom affixed configuration. In this setup the mounting frame is at an angle greater than 90. To change the incline the upper part of the windscreen will move outward to bring it closer to 90.

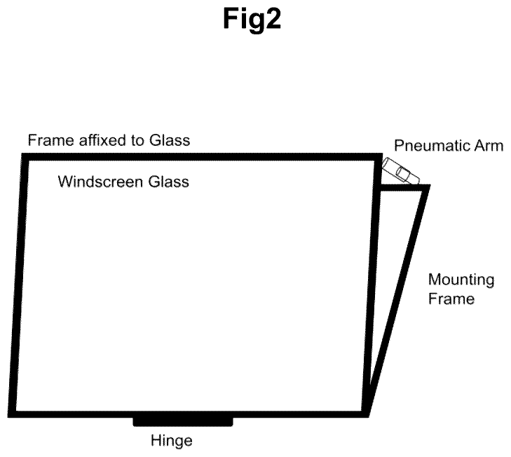

FIG. 3 is a pictorial view of the windshield with top affixed configuration. In this setup, the mounting frame is closer to a vertical angle. To change the incline the bottom part of the windscreen will move outward.

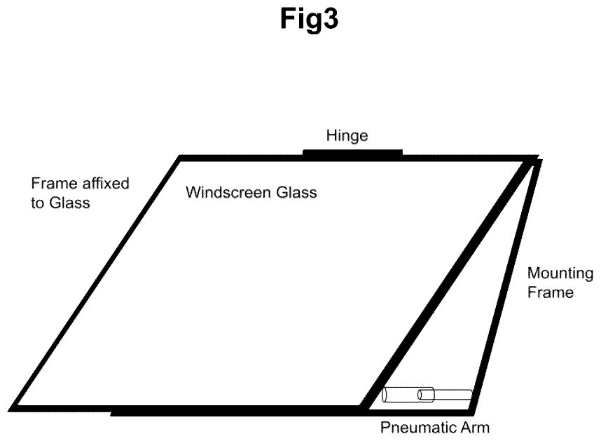

The drawings provide a model of the invention, but other forms are possible. This example is meant to illustrate, not limit.

### DETAILED DESCRIPTION OF THE INVENTION

Multiple pneumatic arms can be used to adjust the windshield angle. The number of pneumatic arms and configuration will depend on the windshield shape and design. The gap created between the static and dynamic frames can be covered with flexible fabric or cascading rigid material.

To reduce the angle with direction of motion the upper pneumatic arms will be extended while the lower pneumatic arms will be retracted. This will result in a windshield that is closer to a vertical angle. In this position the air drag is increased as air faces maximum resistance and starts to flow from above as well as around the windshield. The visibility during rain or snow increases in this position.

To increase the angle with direction of motion the upper pneumatic arms will be retracted while the lower pneumatic arms will be extended. This will result in a windshield that is higher than a vertical angle. In this position the air drag is reduced as the majority of the air flow is directed above the windshield. The overall air drag reduces in this position. The component of acceleration due to gravity on a liquid like rain drops, directly opposes the air flow that impacts the surface of the water on a wet windshield. This causes reduced visibility as water does not flow off easily.

The windshield angle can be controlled using an actuator based on speed and weather conditions in real time.

Wipers can be mounted on the windshield frame itself, or on the vehicle front.

1. A windshield device for automobiles comprising: Windshield, frame or frameless windshield linked to a static mounting frame, where the windshield position can be adjusted. The top as well as bottom can come forward or go inward to change the angle of the windshield with respect to the direction of motion. Driving means for changing position of glass frame/frameless with respect to the static frame; Cover mechanism for the gap between glass frame/frameless and static/mounting frame.

2. Windshield, frame or frameless windshield linked to a static frame; where the windshield is hanging on a static frame with the top fixed to a hinge mechanism; the bottom of the windshield can come forward or go inward to change the angle of the windshield with respect to the direction of motion; driving means for changing position of windshield frame/frameless with respect to the static frame.

3. Windshield, frame or frameless windshield linked to a static frame, where it is standing on a static frame with bottom fixed to a hinge mechanism. The top can come forward or go inward to change the angle of the windshield with respect to the direction of motion. Driving means for changing position of glass frame/frameless with respect to the static frame.
